(19) United States
(12) Patent Application Publication
(10) Pub. No.: US 2014/0114862 A1
(43) Pub. Date: Apr. 24, 2014

(54) SYSTEM AND METHOD FOR A CONSUMER TO MERCHANT NEGOTIATION

(71) Applicant: Netotiate, Inc., Newton Upper Falls, MA (US)

(72) Inventors: Keren Zimmerman, Tel Aviv (IL); Noam Javits, Tel Aviv (IL)

(73) Assignee: NETOTIATE, INC., NEWTON UPPER FALLS, MA (US)

(21) Appl. No.: 14/146,407

(22) Filed: Jan. 2, 2014

Related U.S. Application Data
(63) Continuation-in-part of application No. 13/420,048, filed on Mar. 14, 2012.
(60) Provisional application No. 61/581,304, filed on Dec. 29, 2011.

(51) Int. Cl. G06Q 50/18; G06Q 10/10

(52) U.S. Cl. CPC G06Q 50/188; G06Q 10/10
USPC 705/80

(57) ABSTRACT

A system and method for a consumer-to-merchant electronic negotiation is provided. The method includes receiving a time-limited initial binding offer from a consumer device for purchasing at least one product of choice from at least one merchant of choice responsive to the at least one product displayed on the consumer device and being offered for sale, wherein the initial binding offer includes at least an offered price for the product of choice, the product of choice, and the at least one merchant of choice, further wherein the initial offer expires after a predefined timeframe; determining whether the initial binding offer received from the consumer device is a valid offer for the product of choice; analyzing the initial binding offer using at least one first preconfigured rule received from the merchant device; and generating a time-limited merchant response respective to the analysis of the initial binding offer.

### CROSS REFERENCE TO RELATED APPLICATIONS

This application is a continuation-in-part application of U.S. patent application Ser. No. 13/420,048, filed Mar. 14, 2012 now pending, which claims the benefit of U.S. provisional application No. 61/581,304 filed on Dec. 29, 2011, the contents of which are herein incorporated by reference.

### TECHNICAL FIELD

The invention generally relates to a computerized negotiation platform for electronic commerce (E-commerce) websites, and more specifically to anonymous negotiation platforms between consumers and merchants.

### BACKGROUND

The way people shop has significantly progressed since the development of the worldwide web (WWW). Consumers can now shop from the convenience of their home, office, or while on the road using portable devices. Popular on-line shopping websites, such as Amazon.com®, allow consumers to purchase goods directly through the website. From a merchant's point of view, such websites allow access to a worldwide market of consumers.

The services provided by websites such as Shopping.com, PriceGrabber.com, Nextag, and a few others, belong to a category of web sites that provide comparison shopping engines (CSE) that assist consumers by presenting prices and information about a product the consumer may be interested in purchasing. In response to a consumer's query, the consumer is provided with a list of possibilities based on characteristics such as price and popularity. The CSE is generally considered to be an effective tool for consumers.

As another example, Priceline.com® allows a consumer to make a bid for a traveling service, such as a hotel room reservation. In response, the service provider (e.g., either Priceline.com or the hotel), can either accept or reject that bid. Subsequently, the consumer can either search for another alternative or raise the bid until that price is accepted by the service provider. The disadvantage of such an approach is that the consumer does not know the particulars of the vendor or service provider. For example, the consumer selects the area and level of a hotel he/she desires to stay at, but the consumer cannot bid on a specific hotel. Further, all bids placed by the consumer are binding upon acceptance and no true negotiation take place.

It would therefore be advantageous to overcome the limitations of the prior art by providing an effective way for a consumer and a supplier to negotiate. It would be further advantageous to the consumer if such negotiation would be anonymous by nature.

### SUMMARY

Certain embodiments disclosed herein include a system and method for a consumer-to-merchant electronic negotiation. The method comprises receiving a time-limited initial binding offer from a consumer device for purchasing at least one product of choice from at least one merchant of choice in response to the at least one product displayed on the consumer device and being offered for sale, wherein the initial binding offer includes at least an offered price for the product of choice, the product of choice, and the at least one merchant of choice, wherein the initial offer expires after a predefined timeframe; determining whether the initial binding offer received from the consumer device is a valid offer for the product of choice; analyzing the initial binding offer using at least one first preconfigured rule received from the merchant device; and generating a time-limited merchant response respective of the analysis of the initial binding offer.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention will be apparent from the following detailed description taken in conjunction with the accompanying drawings.

FIG. 1 is a schematic diagram of a system in accordance with an embodiment of the invention;

FIGS. 2A-B are flowcharts describing the operation of the system in accordance with an embodiment of the invention; and

FIG. 3 is a flowchart describing a process of receiving the response from a merchant in accordance with an embodiment of the invention.

### DETAILED DESCRIPTION

The embodiments disclosed herein are only examples of the many possible advantageous uses and implementations of the innovative teachings presented herein. In general, statements made in the specification of the present application do not necessarily limit any of the various claimed inventions. Moreover, some statements may apply to some inventive features but not to others. In general, unless otherwise indicated, singular elements may be in plural and vice versa with no loss of generality. In the drawings, like numerals refer to like parts through several views.

The various exemplary embodiments discussed herein enable consumer-to-merchant negotiation of a business transaction. The consumer identifies a product to purchase and initiates an offer to purchase the product at a price of his or her choice from a merchant of choice. In an embodiment, the consumer is allowed to make a single offer with respect to each single product of a specific merchant, as well as multiple offers to multiple respective merchants for the same product which cannot be repeated until a response from the merchant is received or the time for accepting an offer has otherwise expired. Each offer is preferably anonymous and binding. The merchant is notified of the offer, preferably anonymously. The merchant responses to the offer in real time and can accept the offer as is, decline the offer, or provide one or more counter offers, all within a limited time frame from receipt of the offer. Throughout the process, respective data is saved into a database for the purpose of ranking the consumer and the merchant based on the transaction data.

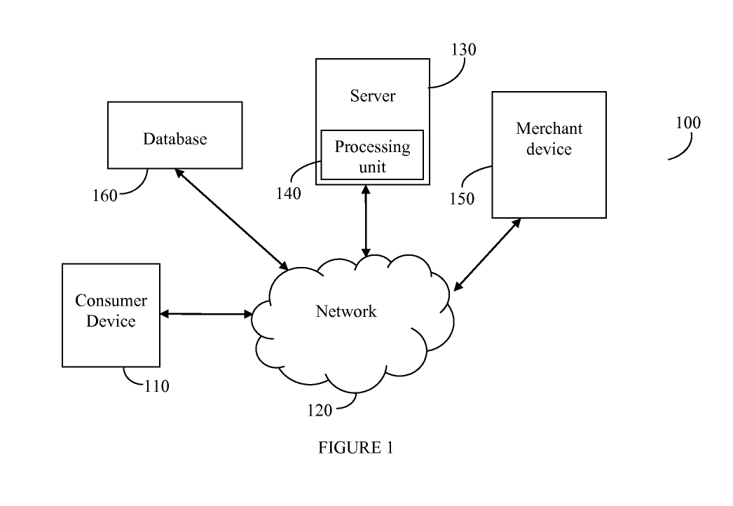

FIG. 1 depicts an exemplary and non-limiting schematic diagram of a system 100 utilized to describe various embodiments of the invention. Accordingly, a consumer by means of a consumer device 110, such as but not limited to, a personal computer (PC), a laptop computer, a mobile device, etc., is connected to a network 120. The network 120 can be wired or wireless, a local area network (LAN), a wide area network (WAN), a metro area network (MAN), the Internet, the worldwide web (WWW), the like, and any combinations thereof.

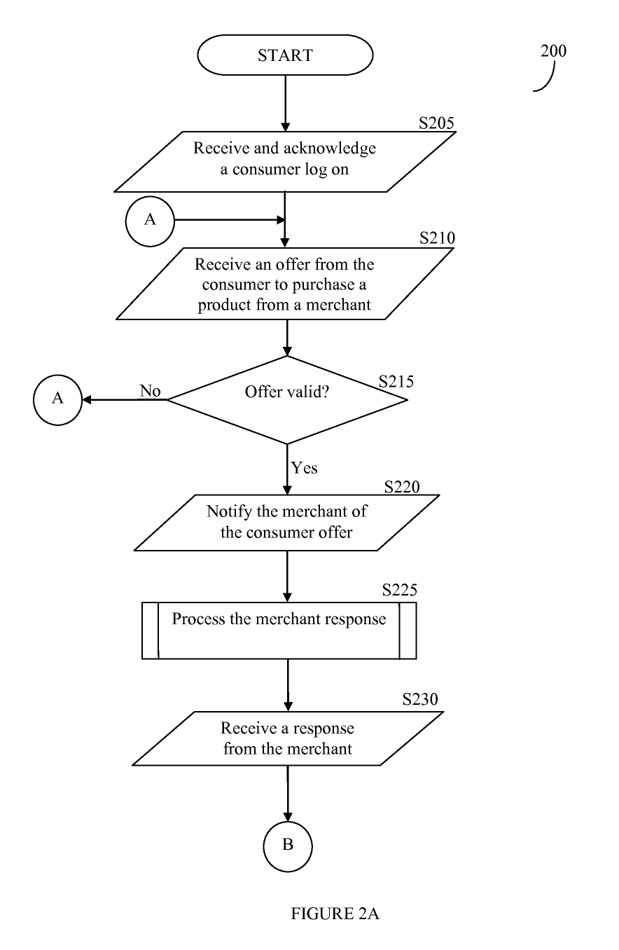

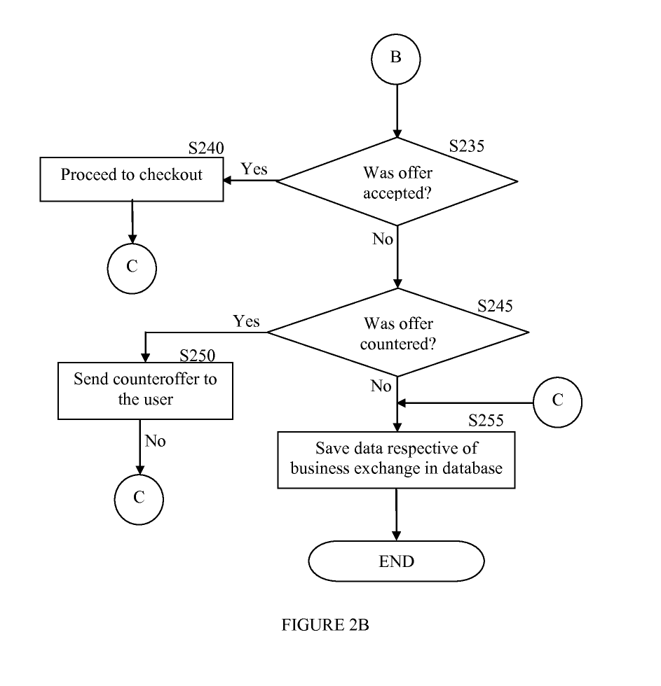

By communication from the consumer device 110, the consumer can communicate with a mediatorial server 130 for the purpose of making an offer for a product and as further explained herein below with respect of FIG. 2. The offer, which is binding on the consumer upon acceptance, is then transferred, preferably anonymously, i.e., without the consumer's identifying information, to the merchant's device 150 respective to the merchant from which the consumer desires to make the purchase. The merchant device may be one of a server, a personal computer, a smart phone, a mobile device, and the like.

It should be further noted that certain processing tasks related to the merchant can be performed by the merchant's device 150 in conjunction with an engine (not shown) operative on the mediatorial server 130. For example, the merchant can configure the engine to respond either autonomously or responsive to inputs provided from the merchant device 150. As another example, the engine operative on the server 130 can automatically generate decline or acceptance messages based on a predetermined threshold of the decline/acceptance conditions set by the merchant. By using the engine operative on the mediatorial server 130, the merchant is able to predetermine the decline or acceptance conditions. Thus, when a counter offer is made, the system automatically declines or accepts the counter offer based on the merchant's determinations.

In one embodiment, the mediatorial server 130 checks the offer made by the consumer and validates that it is in fact a valid offer. A valid offer is an offer that was checked for consistency, was not provided to the server 130 within a forbidden timeframe, or was otherwise provided within an allowed timeframe where for example, the consumer is identified as having a valid form of payment that is consistent with the offer made, and so on and so forth. The merchant may respond via the server 130 with an acceptance, a rejection, or a counter offer to the offer made by the consumer.

All data respective to the entire transaction between the consumer and the merchant is saved in the database 160. The withholding of the consumer information from the merchant can be maintained indefinitely, until the offer is accepted by the merchant or until a counteroffer is accepted by the consumer. It should be noted that a server such as the server 130 typically comprises a processing unit such as a processor 140 that is coupled to a memory 145 (not shown). The memory contains instructions that, when executed by the processor 140, result in the performance of the methods discussed herein.

FIGS. 2A and 2B depict an exemplary and non-limiting flowchart 200 describing a method of consumer-to-merchant negotiation of a business transaction in accordance with an embodiment of the invention. The method will be described with reference to the system 100 shown in FIG. 1.

Referring now to FIG. 2A, in S205 a server, for example the server 130, receives and acknowledges a log on or identification of a consumer by means of a consumer device such as consumer device 110. In S210, the server 130 receives an offer from the consumer to purchase a specific product from a specific merchant as selected by the consumer. The consumer is allowed to make a single offer for a single product to a specific merchant. The consumer may remain anonymous to the merchant and the offer is provided uniquely to the merchant selected by the consumer. In another embodiment, the consumer is allowed to make multiple offers for a single product provided by multiple merchants. An offer typically includes at least the product and the price the consumer wishes to pay. The offer is also submitted with the consumer's selected merchant or merchants.

In S215 it is checked whether the offer received by the consumer is valid, if so, execution continues with S220; otherwise, execution terminates (see FIG. 2B). In one embodiment, the consumer can change the offer a predetermined number of times if the offer was found invalid. The determination of whether the offer is valid is based on criteria provided to the server by the merchant.

In S220, the server 130 notifies the merchant of the consumer offer. In response, the merchant, by means of, e.g., the merchant device 150, generates a response to the consumer offer. The response may include, for example, a message indicating that the consumer's offer is accepted, is rejected, or that the merchant wishes to counter the consumer offer. It should be noted that such a response may be automatic based on an agent operative on the merchant's device 150. It should further be noted that, regardless of how the response is generated, the response from the merchant is sent to the user in real-time. Particularly, a time frame is predefined to the merchant's response, e.g., 15 seconds, to ensure that any responses by the merchant are presented to the customer in real-time or not presented at all.

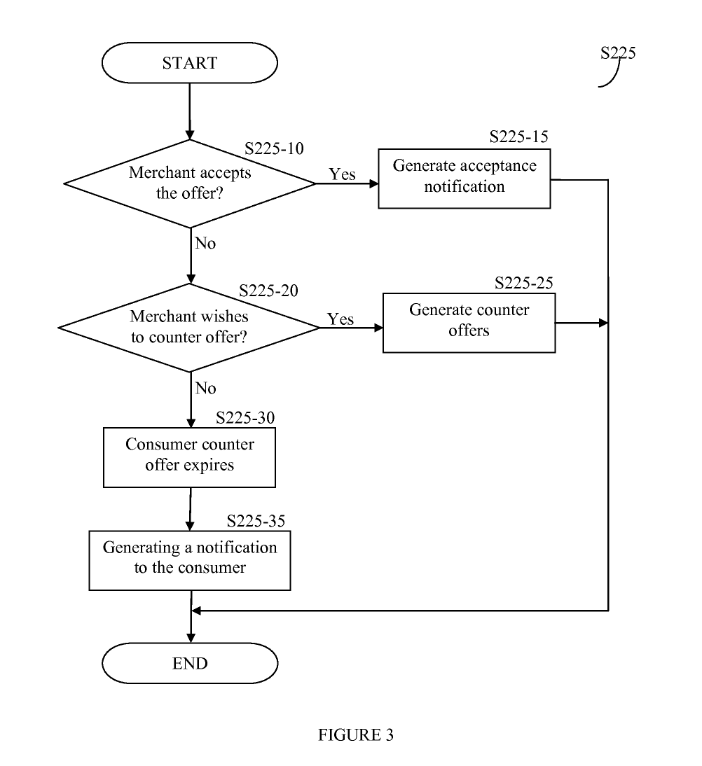

In S222, the response from the merchant is received. The merchant has a limited timeframe to respond to the consumer offer and, if the response diverges from this timeframe, the response is discarded. This limited timeframe of the consumer offer may be a default value set by the server 130, or a value that is set by the consumer or by the server 130 as part of the process of making an offer. In the latter case, it is possible that the validity of the offer will include checking that the timeframe set by the consumer is consistent with merchant requirements as well as, or alternatively, with the server 130 requirements. In S225, the merchant response is processed by the server 130 as described in detail in FIG. 3. The output of the response processing is an acceptance notification indicating the consumer offer has been accepted, a decline notification indicating that the consumer offer has been declined, or a counteroffer generated for the consumer. In S230, the response from the merchant is received.

Referring now to FIG. 2B, in S235, it is checked whether the consumer offer was accepted, and if so, execution continues with S240; otherwise execution continues with S245. In S240, the execution continues to the checkout where the server 130 causes execution of a billing transaction which includes the charging of the consumer for the product for which the consumer made an offer. In an embodiment, offers made by the consumer are binding upon acceptance and, as such, include billing information.

In S245, it is checked whether one or more real-time counteroffers for the consumer was generated and, if so, execution continues with S250, where the one or more counteroffers is sent to the consumer; otherwise, execution continues with S255. It should be noted that if a counter offer is made, the consumer may or may not accept one of the time-limited counter offers. In one embodiment, if the consumer wishes to counter the merchant offer, the process occurs similarly to that of a new transaction, potentially without the need for the identification step S205. It should be noted that continued offers and counter-offers occurring back and forth between a consumer and a merchant could effectively constitute a negotiation without formally exchanging words. Anonymity of the consumer with respect to the merchant may be maintained indefinitely or until at least an offer or counter offer is accepted. In S255, all data respective to the consumer/merchant interaction is saved in database 160.

In one embodiment, both the consumer and the merchant receive a score based on respective current and past transactions using the system 100 and each of them has a personal scorecard displaying his or her score and relative ranking. Based on scores and ranks, the server 130 can better match a consumer and a merchant. For example, when a consumer wishes to purchase a camera, the system may suggest one or more merchants that are willing to negotiate the price of the camera and may further have a ranking that is desirable for the user. In another example, the system can generate a recommendation of a highly ranked consumer to a merchant when the high ranked consumer makes an offer. This is important information to the merchant, who may wish to close a deal with a consumer known to be a serious buyer. Thus, the server 130 using the computed score and ranking, can populate a list of merchants that best fit the consumers' preferences or provide indications to both to enable merchant and consumer to enable to better deals.

FIG. 3 depicts an exemplary and non-limiting flowchart of the process of generating the response by a merchant in S225 based on an offer received from the consumer through the server 130 in accordance with an embodiment. According to one embodiment, the merchant response is provided in real-time, within the time limit of the initial binding offer. The real-time response to the offer received from the consumer enables real-time electronic negotiation between the consumer and the merchant device 150 through the server 130. As an example, a consumer is interested in a microwave of a certain model. The consumer simultaneously compares prices of the microwave in several web sources. In such a case, the real-time response to the consumer's offer incentivizes the consumer to order the microwave from that merchant. In S225-10, it is checked whether the merchant accepts the offer received from the consumer and if so, execution continues with S225-15 where an acceptance notification is generated after which execution of S225 terminates; otherwise, execution continues with S225-20. In S225-20 it is checked whether the merchant wishes to counter the offer and if so, execution continues with S225-25; otherwise, execution continues with S225-30. In S225-25, the server 130 receives from the merchant one or more time-limited counteroffers.

A counteroffer may include, but is not limited to, a price suggested by the merchant, a similar product to the product that the consumer requested to purchase, one or more additional products of the same kind or different, a discount coupon, or any combination thereof. In one embodiment, the server 130 may be configured with a plurality of rules to generate a counteroffer on behalf of the merchant. The plurality of rules may include a price range for a product, the current inventory level of the product, a specific promotion offered by the merchant for the product, similar products that may be of interest to the consumer, and so on. The server 130 may generate a counteroffer based on one or more of the configured rules. The rules may be dynamically updated by the merchant respective of pending offers from the consumer. For example, if the merchant wishes to clear the inventory of a certain product, the merchant may reduce the minimum price of the product even if no offer has been received. It should be appreciated that the server 130 may also autonomously decide whether to accept or decline a consumer offer based on such rules.

In one embodiment, the examination of the offer received by the consumer is made automatically by the merchant device 150 based on predetermined preferences set by the merchant. In S225-30, the consumer offer expires. In S225-35, a notification is generated and sent to the consumer after which execution terminates.

The various embodiments of the invention can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for a real-time consumer-to-merchant electronic negotiation, comprising:
receiving a time-limited initial binding offer from a consumer device for purchasing at least one product of choice from at least one merchant of choice responsive of the at least one product displayed on the consumer device and being offered for sale, wherein the initial binding offer includes at least an offered price for the product of choice, the product of choice, and the at least one merchant of choice, wherein the initial offer expires after a predefined timeframe;
determining whether the initial binding offer received from the consumer device is a valid offer for the product of choice;
analyzing the initial binding offer using at least one first preconfigured rule received from the merchant device; and
generating a merchant response in real-time responsive to the initial binding offer respective of the analysis of the initial binding offer.

2. The method of claim 1, further comprising:
receiving at least one subsequent time-limited offer from the consumer device for the at least one product of choice responsive to the merchant response;
analyzing the at least one subsequent time-limited offer based on at least one second preconfigured rule received from the merchant device; and
generating a subsequent time-limited merchant response from the merchant device respective of the analysis of the at least one second preconfigured rule.

3. The method of claim 2, wherein the subsequent time-limited merchant response is any one of: an acceptance of the subsequent time-limited offer, a decline of the subsequent time-limited offer, and one or more subsequent time-limited counter-offers.

4. The method of claim 3, wherein the first at least one preconfigured rule and the at least one second preconfigured rule are any one of: same rules and different rules.

5. The method of claim 3, wherein the first at least one preconfigured rule and the at least one second preconfigured rule are dynamically updated by the merchant respective of at least one of: a number of pending offers from consumers, and inventory level of the merchant.

6. The method of claim 3, wherein each of the first at least one preconfigured rule and the second at least one preconfigured rule may include a price range for a product, a current inventory level of the product, a specific promotion offered by the merchant for the product, and inclusion of one more similar products that may be of interest to a consumer.

7. The method of claim 6, wherein analyzing the initial binding offer further comprises checking to determine if the initial binding offer satisfies each of the at least one first predefined rules.

8. The method of claim 6, wherein analyzing the initial binding offer further comprises checking to determine if the initial binding offer satisfies each of the at least one second predefined rules.

9. The method of claim 1, wherein the merchant response is one of: an acceptance of the initial offer, a decline of the initial offer, and one or more time-limited counter-offers.

10. The method of claim 1, further comprising:
receiving and acknowledging a consumer log on; and
receiving a selection of a merchant of choice and a product of choice from the consumer device of the consumer.

11. The method of claim 10, further comprising:
creating a personal score card for each merchant and consumer;
ranking the consumer and the merchant based on their past activities and a feedback received from each merchant device and consumer device with respect to the interaction between the consumer and the merchant; and
presenting the rank of the consumer and the merchant in both the consumer personal score card and the merchant personal score card.

12. The method of claim 11, further comprising:
matching the merchant and the consumer based on at least one of: a score card, and a rank.

13. The method of claim 1, wherein the initial binding offer further includes billing information of the consumer, wherein the at least one subsequent offer includes a revised offered price, and wherein each of the initial offer and the at least one subsequent offer is binding upon acceptance by the merchant device.

14. The method of claim 1, wherein determining whether the initial offer is valid further includes at least one of:
checking to determine if the offered price is within a predefined price range for the product of choice; and
checking to determine if the billing information is correct.

15. The method of claim 1, further comprising:
saving in a database information respective to all offers exchanged between the consumer device and the merchant device during the consumer-to-merchant electronic negotiation.

16. A non-transitory computer readable medium having stored thereon instructions for causing one or more processing units to execute the method according to claim 1.

17. A mediatorial server for a consumer-to-merchant electronic negotiation, comprising:
an interface for communicatively connecting a consumer device with at the mediatorial server to receive a time-limited initial binding offer for purchasing at least one product of choice from at least one merchant of choice, wherein the time-limited initial binding offer is generated responsive to the at least one product displayed on the consumer device and offered for sale, further wherein the initial binding offer includes at least an offered price for the product of choice, the product of choice, and the at least one merchant of choice, and further wherein the initial offer expires after a predefined timeframe;
at least one processing unit communicatively connected to the interface; and
a memory having instructions stored therein, the memory communicatively connected to the at least a processing unit, such that the mediatorial server upon execution of the instructions by the at least one processing unit configures the mediatorial server to:
receive the binding initial offer;
determine whether the initial binding offer is a valid offer for the product of choice;
analyze the initial binding offer using one or more preconfigured rules received from the merchant device; and
generate a real-time merchant response respective of the analysis of the initial binding offer.

18. The mediatorial server of claim 17, wherein the mediatorial server is further configured to receive at least one subsequent time-limited offer from the consumer device for the at least one product of choice responsive to the merchant response;
analyze the at least one subsequent time-limited offer based on at least one second preconfigured rule received from the merchant device; and
generate a subsequent time-limited merchant response respective to the analysis of the at least one second preconfigured rule.

19. The mediatorial server of claim 18, wherein the subsequent time-limited merchant response is any one of: an acceptance of the subsequent time-limited offer, a decline of the subsequent time-limited offer, and one or more subsequent time-limited counter-offers.

20. The mediatorial server of claim 18, wherein the at least one first preconfigured rule and the at least one second preconfigured rule are any one of: same rules, and different rules.

21. The mediatorial server of claim 18, wherein the first at least one preconfigured rule and the at least one second preconfigured rule are dynamically updated by the merchant respective to at least one of: a number of pending offers from consumers, and inventory level of the merchant.

22. The mediatorial server of claim 18, wherein each of the first at least one preconfigured rule and the second at least one preconfigured rule may include a price range for a product, a current inventory level of the product, a specific promotion offered by the merchant for the product, and one more similar product that may be of interest to the consumer.

23. The mediatorial server of claim 18, wherein the mediatorial server is further configured to check if the initial binding offer satisfies each of the at least one first predefined rules.

24. The mediatorial server of claim 18, wherein the mediatorial server is further configured to check if the initial binding offer satisfies each of the at least one second predefined rule.

25. The mediatorial server of claim 17, wherein the server is communicatively connected to a database configured to store the preconfigured rules.

26. The mediatorial server of claim 17, wherein the time-limited merchant response is one of: an acceptance of the initial offer, a decline of the initial offer, and one or more time-limited counter-offers.

27. The mediatorial server of claim 17, wherein the mediatorial server is further configured to:
receive and acknowledge a consumer log on; and
receive a selection of a merchant of choice and a product of choice from a consumer device of the consumer.

28. The mediatorial server of claim 17, wherein the mediatorial server is further configured to:
create a personal score card for each merchant and consumer;
rank the consumer and the merchant based on their past activities and a feedback received from each merchant device and consumer device with respect to the interaction between the consumer and the merchant; and
present the rank of the consumer and the merchant in the consumer's and the merchant's personal score cards.

29. The mediatorial server of claim 17, wherein the mediatorial server is further configured to:
match a merchant and a consumer based on at least one of: a score card, and a rank.

30. The mediatorial server of claim 17, wherein the initial binding offer further includes billing information of the consumer, wherein the at least one subsequent offer includes a revised offered price, and further wherein each of the initial offer and the at least one subsequent offer is binding upon acceptance by the merchant device.

31. The mediatorial server of claim 17, wherein the mediatorial server is further configured to:
check to determine if the offered price is within a predefined price range for the product of choice; and
check to determine if the billing information is correct in order to determine the validity of the offer.

32. The mediatorial server of claim 31, wherein the mediatorial server is further configured to save in the database information respective to all offers exchanged between the consumer device and the merchant device during the consumer-to-merchant negotiation.
